(19) United States
(12) Patent Application Publication
(10) Pub. No.: US 2017/0149910 A1
(43) Pub. Date: May 25, 2017

(54) NON-TRANSITORY COMPUTER-READABLE RECORDING MEDIUM, COMMUNICATION CONTROL METHOD, AND COMMUNICATION CONTROL DEVICE

(71) Applicant: FUJITSU LIMITED, Kawasaki-shi (JP)

(72) Inventors: Chiharu Yamamoto, Kawasaki (JP); Ryohei MORISHITA, Yokohama (JP); Hiroyoshi Kasai, Yokohama (JP); NORIE TACHIBANA, Kawasaki (JP); Norihiko IGARASHI, Kawasaki (JP); Masatomo Yasaki, Kako (JP); Ryoichi AKIYAMA, Kagoshima (JP)

(73) Assignee: FUJITSU LIMITED, Kawasaki-shi (JP)

(21) Appl. No.: 15/278,088

(22) Filed: Sep. 28, 2016

(30) Foreign Application Priority Data
Nov. 19, 2015 (JP) 2015-227103

(51) Int. Cl. H04L 29/08

(52) U.S. Cl. CPC H04L 67/18; H04L 67/14; H04L 67/10

(57) ABSTRACT

A non-transitory computer-readable recording medium having stored therein a communication control program that causes a computer to execute a process, the process includes receiving a request to be transmitted to an information processing system coupled to a first network that selectively allows the computer to perform access from an outside of a network, from a terminal device coupled to a second network being different from the first network, changing, when a response obtained as a result of transmitting the request to the information processing system includes location information indicating an access destination in the first network, the location information to location information for accessing the information processing system, and transmitting the response including the changed location information to the terminal device.

### CROSS-REFERENCE TO RELATED APPLICATION

This application is based upon and claims the benefit of priority of the prior Japanese Patent Application No. 2015-227103, filed on Nov. 19, 2015, the entire contents of which are incorporated herein by reference.

### FIELD

The embodiments discussed herein are related to a non-transitory computer-readable recording medium, a communication control method, and a communication control device.

### BACKGROUND

A system realized by a plurality of servers (hereinafter referred to as a business system) is operated within an intra-network in some cases. In these cases, access to the business system is assumed to be access from the inside of the intra-network.

In the business system above, when the business system is accessed from an external network (for example, the Internet) that is different from the intra-network, access control is performed by an intermediate server such as a gateway.

As a related technology, a technology for mediating communication via the Internet between an internal device that is a device included in the Intranet and an external device that is not included in the Intranet has been proposed (see, for example, Patent Document 1).

[Patent Document 1] Japanese Laid-open Patent Publication No. 2015-69625

### SUMMARY

According to an aspect of the embodiments, a non-transitory computer-readable recording medium having stored therein a communication control program that causes a computer to execute a process, the process includes receiving a request to be transmitted to an information processing system coupled to a first network that selectively allows the computer to perform access from an outside of a network, from a terminal device coupled to a second network being different from the first network, changing, when a response obtained as a result of transmitting the request to the information processing system includes location information indicating an access destination in the first network, the location information to location information for accessing the information processing system, and transmitting the response including the changed location information to the terminal device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of the entire configuration of a system including a business system.

FIG. 2 is a functional block diagram illustrating an example of an intermediate server.

FIG. 3 is a flowchart illustrating an example of definition information registration processing.

FIG. 4 illustrates an example of definition information.

FIG. 5 illustrates examples of various tables.

FIG. 6 is a sequence chart (no. 1) illustrating an example of a flow of processing on a request and a response.

FIG. 7 illustrates an example of a request transmitted from a mobile terminal to an intermediate server.

FIG. 8 is a flowchart illustrating an example of processing for changing a URL specified by a request.

FIG. 9 illustrates a specific example (no. 1) of processing for changing a URL specified by a request.

FIG. 10 illustrates examples of a response received by a mobile terminal and a request transmitted by the mobile terminal.

FIG. 11 is a sequence chart (no. 2) illustrating an example of a flow of processing on a request and a response.

FIG. 12 illustrates a specific example (no. 2) of processing for changing a URL specified by a request

FIG. 13 is a flowchart illustrating an example of processing for changing a URL specified by a response.

FIG. 14 illustrates a specific example of processing for changing a URL specified by a response.

FIG. 15 is a sequence chart (no. 3) illustrating an example of a flow of processing on a request and a response.

FIG. 16 illustrates a specific example (no. 3) of processing for changing a URL specified by a request.

FIG. 17 illustrates an example of a hardware configuration of an intermediate server.

### DESCRIPTION OF EMBODIMENTS

A business system transmits, to an access source, a response to a request. The transmitted response may include a Uniform Resource Locator (URL) that indicates an access destination to be accessed next by the access source.

In this case, it is valid to access the URL included in the response from the inside of a prescribed network in which the business system operates.

On the other hand, it is not valid to access the URL included in the response from an external network, and therefore access from the external network according to the URL is denied by the intermediate server. Accordingly, it is difficult to access the business system from the external network.

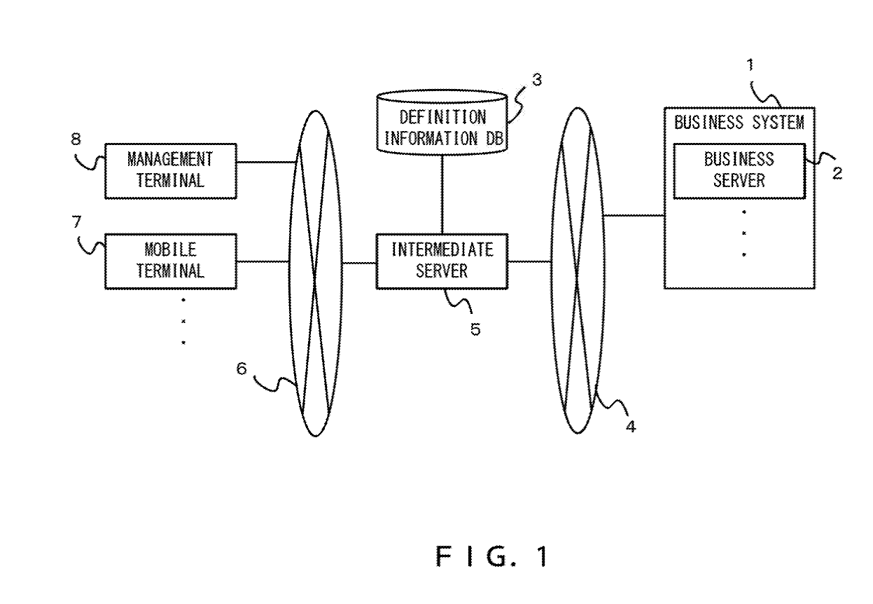

Embodiments are described below with reference to the drawings. FIG. 1 illustrates an example of the entire configuration of a system according to the embodiments. In the example illustrated in FIG. 1, a business system 1 is a system that operates a prescribed business.

The business system 1 includes one or more business servers 2. In the embodiments, the business system 1 is assumed to include a plurality of business servers 2. One business server 2 may be included in the business system 1.

The respective business servers 2 are servers that perform various types of processing for operating a prescribed business. The business system 1 is realized by the respective business servers 2. The business system 1 is an example of an information processing system.

The plurality of business servers 2 may be servers that are physically different from each other, or may be virtual servers that are realized by one server.

A definition information database 3 stores one or more pieces of definition information that define rules for changing a URL included in a request and a response to the business system 1.

The definition information database 3 is installed between a first network 4 and a second network 6. In the embodiments, the definition information database 3 is connected to an intermediate server 5. In the example of FIG. 1, the definition information database is expressed as a “definition information DB”.

The business system 1 is coupled to the first network 4. The first network 4 may be, for example, an intra-network such as an in-enterprise network. In this case, the business system 1 is located in an intra-network.

The intermediate server 5 is arranged between the first network 4 and the second network 6, and the intermediate server 5 performs communication control between the first network 4 and the second network 6. The intermediate server 5 is an example of a communication control device or a computer.

The first network 4 and the second network 6 are networks different from each other. As an example, the second network 6 may be the Internet.

The second network 6 is connected to a plurality of mobile terminals 7 and a management terminal 8. The mobile terminal 7 is an example of a terminal device. The terminal device may be a mobile terminal that performs wireless communication, as described as an example in the embodiments, or may be a fixed terminal that performs wired communication. One mobile terminal 7 may be connected to the second network 6.

The management terminal 8 is a terminal that manages the intermediate server 5. The management terminal 8 receives an input operation of an operator (for example, an administrator) that operates the management terminal 8, and transmits information relating to the received operation to the intermediate server 5.

In the embodiments, the business system 1 is assumed to be used within the first network 4. As an example, when a certain terminal device in the first network 4 uses the business system 1, the terminal device transmits a request (request data) to the business system 1.

The request includes a URL indicating an access destination. The request from the terminal device is transmitted to the access destination that is indicated by the URL specified by the request in the business system 1. The business system 1 transmits, to the terminal device that is an access source, a response (response data) to the request. The URL is an example of location information.

The response may include, for example, a result of a response to the request (a result indicating success or failure) or prescribed information. The response may include a URL used to make the terminal device access the business system 1 again.

As an example, a business server 2 that has processed the request in the business system 1 may include a URL used to access another business server 2 in the response.

In order to distribute loads on respective business servers 2 in the business system 1, the business server 2 that has processed the request may include a URL used to access another business server 2 in the response.

The business server 2 that has processed the request may include a URL used to access the business server 2 itself in the response.

When the response includes the URL above, the terminal device in the first network 4 accesses an access destination indicated by the URL in the business system 1. The URL above is a URL that is valid within the first network 4, and therefore the terminal device in the first network 4 can access the access destination indicated by the URL.

In the embodiments, accessing the business system 1 is not only allowed from the inside of the first network 4, but is also allowed from the second network 6 that is different from the first network 4. However, in order to, for example, ensure security of the business system 1, access from the second network 6 to the business system 1 is collectively controlled by the intermediate server 5.

In the example of FIG. 1, a plurality of mobile terminals 7 are connected to the second network 6. The respective mobile terminals 7 do not transmit a request directly to the business system 1, but transmit the request to the intermediate server 5.

The intermediate server 5 transmits a request to the business system 1 in accordance with the request received from each of the mobile terminals 7. The intermediate server 5 also receives a response from the business system 1, and transmits the response to a mobile terminal 7 that is a transmission source of the request. Accordingly, the intermediate server 5 collectively controls access from the second network 6.

As described above, the business system 1 may include a URL used to access the business system 1 again in a response. The URL included in the response is a URL that is valid within the first network 4.

Because the intermediate server 5 collectively controls access from the second network 6, the mobile terminal 7 that is an access source transmits, to the intermediate server 5, a request that specifies the URL included in the response.

The specified URL is a URL that is valid within the first network 4, but is not a URL that is valid within the second network 6. The intermediate server 5 denies the request transmitted by the mobile terminal 7 because access according to an invalid URL has been performed. Accordingly, the business system 1 does not receive the request.

The intermediate server 5 according to the embodiments changes the URLs included in the request and the response in order to enable access control from the outside of the first network 4.

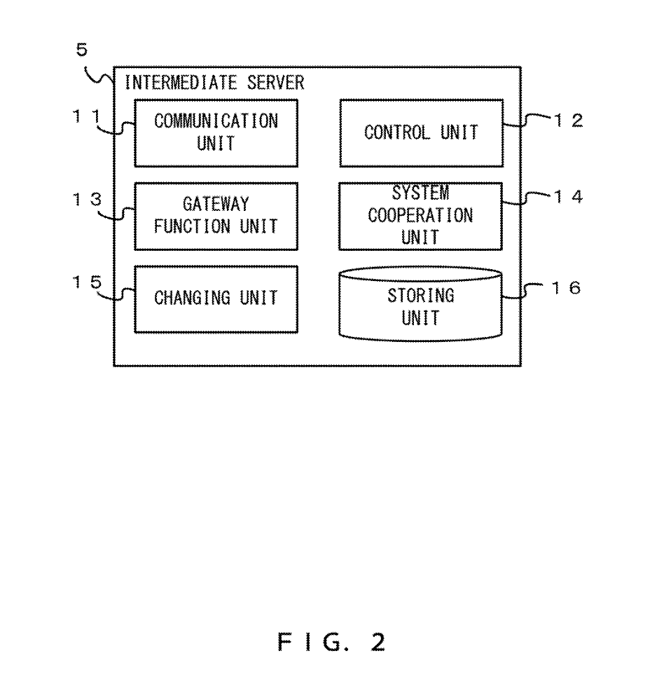

An example of the intermediate server 5 is described next with reference to the example of FIG. 2. The intermediate server 5 includes a communication unit 11, a control unit 12, a gateway function unit 13, a system cooperation unit 14, a changing unit 15, and a storing unit 16.

The communication unit 11 performs communication via the first network 4 and the second network 6. Communication via the first network 4 and communication via the second network may be realized by different communication units (communication interfaces).

The control unit 12 performs various types of control. The gateway function unit 13 controls communication with the second network 6

As an example, the gateway function unit 13 performs authentication or the like on access from the second network 6. The intermediate server 5 collectively controls access from the second network 6 to the business system 1 such that security of the business system 1 is assured.

The system cooperation unit 14 controls communication with the business system 1. As an example, when the gateway function unit 13 performs authentication on a request transmitted from the second network 6, and authentication is successful, the gateway function unit 13 reports a result. The system cooperation unit 14 may performs control to transmit a request to the business system 1 in accordance with the result.

The changing unit 15 changes a URL that is included in a request received from the second network 6 and a URL that is included in a response received from the first network 4. The changing unit 15 maybe included respectively in the gateway function unit 13 and the system cooperation unit 14.

The changing unit 15 according to the embodiments changes a URL in accordance with a URL included in a request or a response and definition information stored in the definition information database 3. The storing unit 16 stores various types of information.

### <Example of Definition Information>

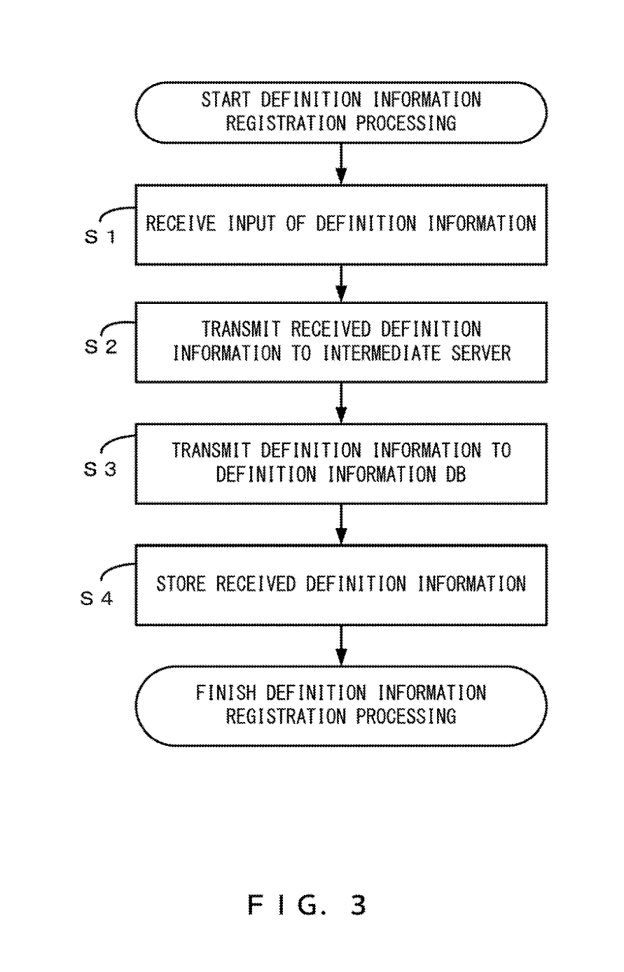

An example of registration of definition information is described next. FIG. 3 is a flowchart illustrating an example of definition information registration processing. An operator that operates the management terminal 8 (for example, the administrator above) inputs definition information to the management terminal 8. The management terminal 8 receives an input of the definition information (step S1).

The management terminal 8 transmits the received definition information to the intermediate server 5 via the second network 6 (step S2). The intermediate server 5 transmits the definition information to the definition information database 3 (step S3).

The definition information database 3 stores the received definition information (step S4). Consequently, the definition information is registered in the definition information database 3. When the processes of steps S1 to S4 are performed plural times, plural pieces of definition information are registered in the definition information database 3.

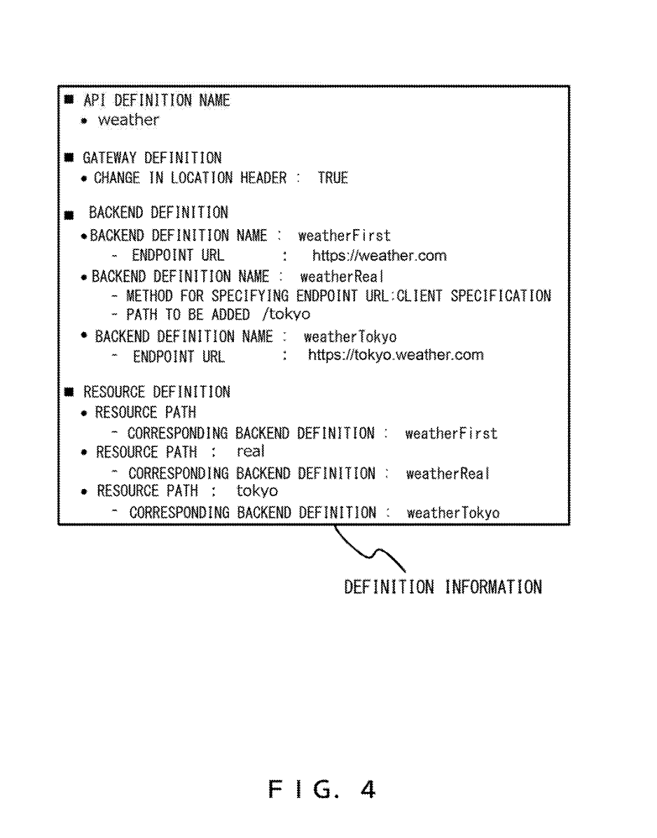

An example of definition information is described next with reference to the example of FIG. 4. In the embodiments, the definition information is definition information relating to an application programming interface (API). Hereinafter, the definition relating to the API is also referred to as an API definition.

The definition information includes items, an API definition name, a gateway definition, a backend definition, and a resource definition. The definition information may include other items.

The API definition name is a character string indicating the name of definition information. The gateway definition indicates whether a location header will be changed.

The location header is information included in a header portion of a response, and the location header indicates a URL of an access destination that a destination of the response accesses next. The backend definition is information that defines a final access destination in the business system 1.

The item “backend definition” specifies a correspondence relationship between a backend definition name and an endpoint URL. The endpoint URL is a URL indicating a final access destination in the business system 1.

The endpoint URL can be arbitrarily specified by a client (in the embodiments, the mobile terminal 7). In the example of FIG. 4, when a method for specifying the endpoint URL is “client specification”, the endpoint URL is specified arbitrarily.

In the backend definition name, an addition of a path is specified in some cases. When a “path to be added” has been specified in the backend definition name, a specified path is added to the arbitrarily specified endpoint URL.

The item “resource definition” specifies a correspondence relationship between a resource path included in a received request URL and the backend definition name. The resource path is a character string included in the URL, and specifies a relationship with the backend definition.

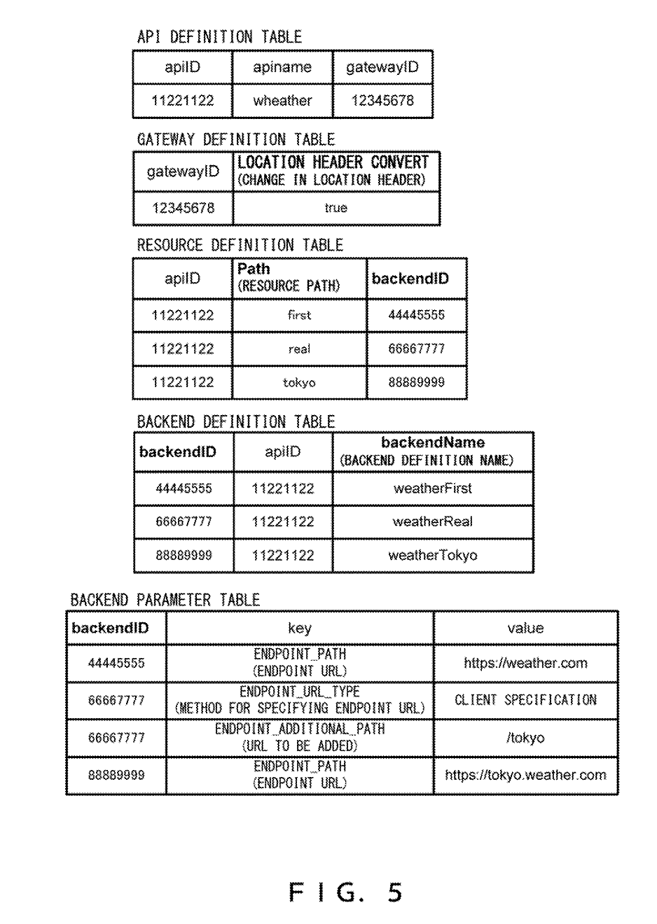

In the embodiments, the definition information is specified by various tables. Examples of the various tables are described with reference to the example of FIG. 5.

An API definition table includes the items “apiId”, “apiName”, and “gatewayId”. “apiId” indicates an identification (ID) that identifies the API. “apiName” indicates the name of the API, and corresponds to the API definition name above.

“gatewayId” indicates an ID that is a key for searching a gateway definition table that specifies whether a location header will be changed. When a value of “locationHeaderConvert” is “true”, a location header included in a response is changed, and when a value of “locationHeaderConvert” is “false”, the location header is not changed.

A resource definition table includes the items “apiId”, “Path”, and “backendId”. The item “Path” indicates the resource path described above. The item “backendId” indicates an ID that is a key for searching a backend definition table.

The backend definition table includes the items “backendId”, “apiId”, and “backendName”. “backendName” indicates the definition name of a backend.

A backend parameter table includes the items “backendId”, “key”, and “value”. “key” corresponds to “backendId”. A plurality of “key”s may correspond to one “backendId”. One “key” corresponds to one “value”.

The definition information illustrated in the example of FIG. 4 is specified by the respective tables illustrated in the example of FIG. 5. The definition information illustrated in the example of FIG. 4 may be specified according to an arbitrary method other than the various tables illustrated in the example of FIG. 5.

### <Example Illustrating Flow of Processing on Request and Response>

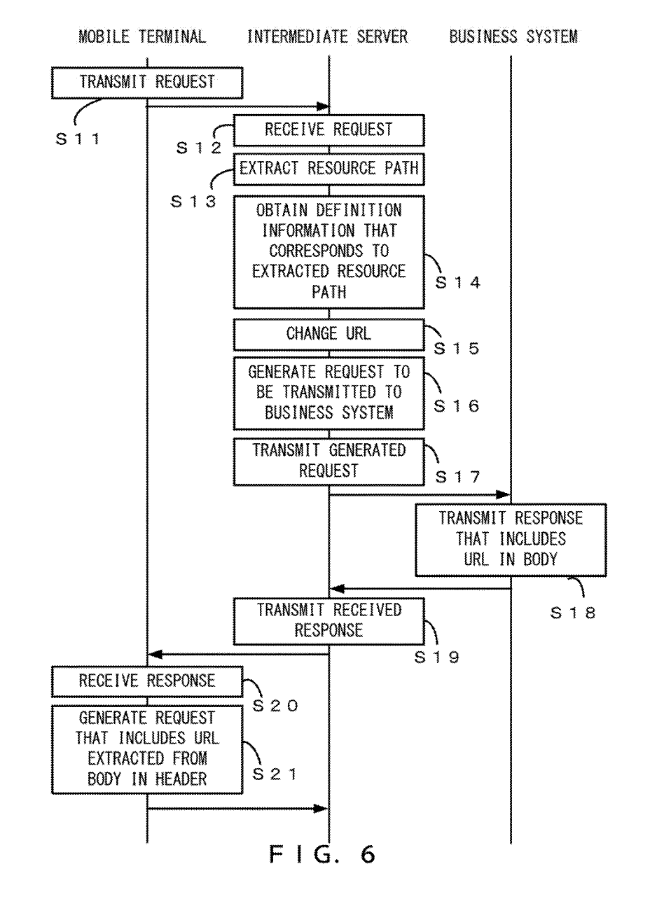

A flow of processing on a request and a response according to the embodiments is described next. As illustrated in the example of FIG. 6, the mobile terminal 7 transmits a request to the intermediate server 5 via the second network 6 (step S11).

Assume that an application (an application program) has been stored in advance in the mobile terminal 7. An operator that operates the mobile terminal 7 (for example, a user) starts the application, and performs a prescribed operation.

The mobile terminal 7 receives the operation. The mobile terminal 7 transmits a request according to the operation to the intermediate server 5. Assume that the request is the first request after the application above has been started.

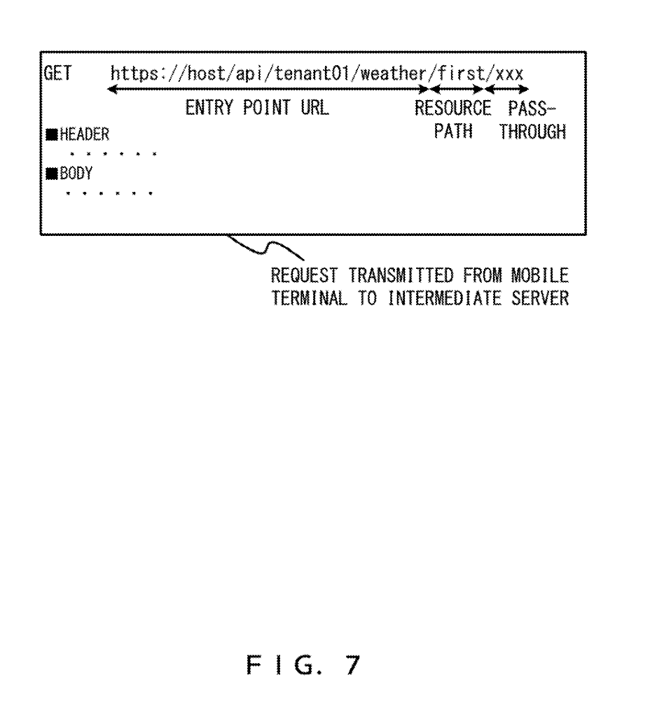

FIG. 7 illustrates an example of a request transmitted from the mobile terminal 7 to the intermediate server 5. The request specifies a URL. In the example of FIG. 7, the URL specified by the request includes an entry point URL, a resource path, and a pass-through. This URL is valid in the second network 6, but is invalid in the first network 4.

The entry point URL indicates a URL of an entry that specifies a URL of a service to be used in the business system 1. In the entry point URL, the last portion “weather” indicates an API definition name of definition information.

In the URL specified by the request, the resource path above is described after the entry point URL. The pass-though is described after the resource path. The resource path is an example of a first character string, and the pass-through is an example of a second character string.

The pass-through is, for example, information that specifies a query that the business server 2 is made to execute or a path of an application program or the like.

In the example of FIG. 6, the intermediate server 5 receives the request (step S12). Upon receipt of the request, the gateway function unit 13 performs authentication or the like on the request. Consequently, security of the business system 1 is assured.

The control unit 12 extracts a resource path that is included in a URL specified by the request (step S13). In the example above, the character string “weather” is extracted. The control unit 12 obtains definition information indicating that an API definition name is “weather” from the definition information database 3 (step S14).

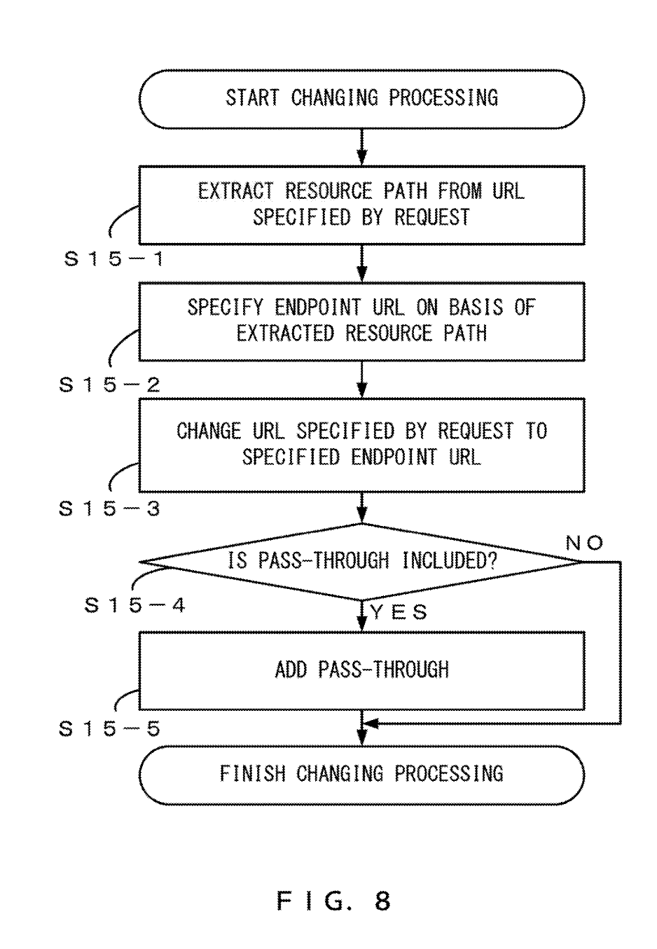

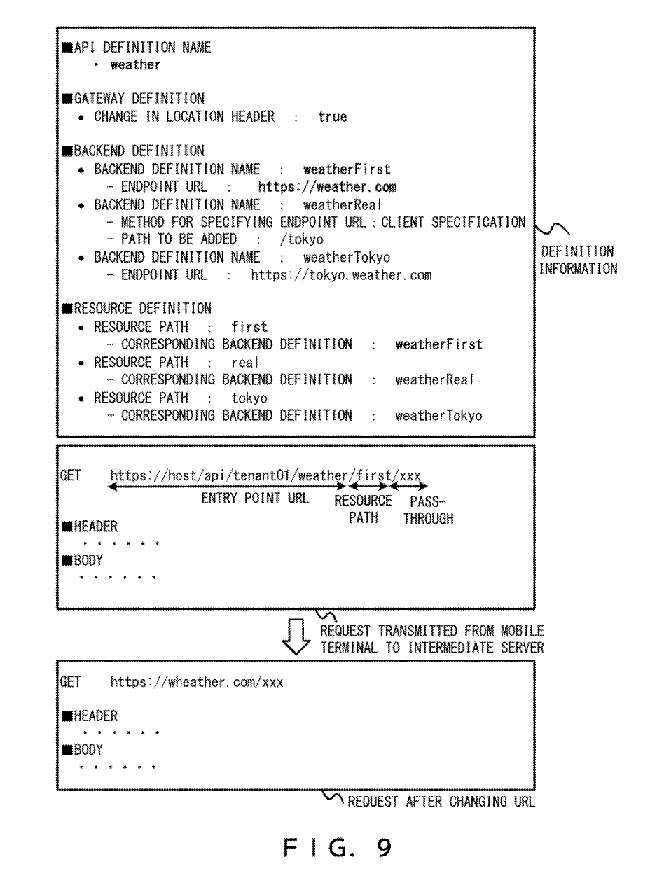

The changing unit 15 changes the URL on the basis of the URL specified by the request and the obtained definition information (step S15). Processing for changing a URL is described with reference to the examples of FIGS. 8 and 9.

FIG. 8 is a flowchart illustrating an example of processing for changing a URL specified by a request. The changing unit 15 extracts the resource path in the URL specified by the request (step S15-1).

In the example of FIG. 9, the extracted resource path is “first”. The changing unit 15 specifies an endpoint URL in accordance with the extracted resource path (step S15-2). For this purpose, the changing unit 15 searches “resource definition” for an item that matches the extracted resource path “first”.

In the example of FIG. 9, the backend definition “weatherFirst” that matches the resource path “first” is detected.

The changing unit 15 searches the backend definition for an item that matches the detected “weatherFirst”. In the example of FIG. 9, an item that matches the backend definition name “weatherFirst” is detected.

The changing unit 15 specifies an endpoint URL that corresponds to the detected backend definition name. In the example of FIG. 9, the specified end point URL is “https://weather.com”. Consequently, an endpoint URL is specified according to the extracted resource path.

The changing unit 15 changes the URL specified by the request to the endpoint URL above (step S15-3). The changing unit 15 determines whether a pass-through is included in the URL specified by the request (step S15-4).

When a pass-through is included (YES in step S15-4), the changing unit 15 adds the pass-through to the specified endpoint URL (step S15-5). When a pass-through is not included (NO in step S15-4), the process of step S15-5 is not performed.

In the example of FIG. 9, a request includes the pass-through “xxx”. The changing unit 15 changes the URL specified by the request to a URL obtained by adding the pass-through to the endpoint URL above. In the example of FIG. 9, the changed URL is “https://weather.com/xxx”. The changed request is a URL that is valid in the first network 4.

As illustrated in the example of FIG. 6, the system cooperation unit 14 generates a request to be transmitted to the business system 1, which specifies the changed URL (step S16).

The communication unit 11 transmits the generated request to the business system 1 via the first network 4 (step S17). The request is transmitted to the business server 2 that is an access destination that is indicated by the URL specified by the request (the changed URL) in the business system 1.

The business server 2 that has received the request transmits a response to the request to the intermediate server 5 (step S18). The business server 2 may make a transmission source of the request transmit another request, for example, in order to distribute a load or to cause another business server 2 to perform processing.

In this case, a URL to be accessed next by the transmission source of the request is included in a body or a header of the response. Assume that, in step S18, the URL to be accessed next is included in the body of the response.

The intermediate server 5 transmits the received response to the mobile terminal 7 that is the transmission source of the request (step S19). The mobile terminal 7 that has received the response extracts the URL above from the body of the response, and generates a request that includes the extracted URL in a header (step S21).

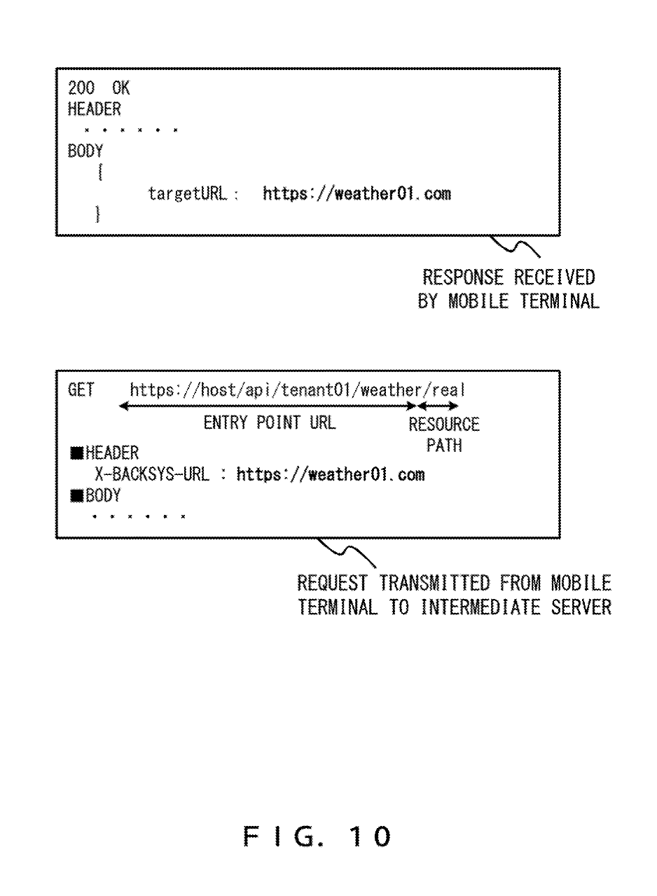

As an example, in the example of FIG. 10, the body of the response received by the mobile terminal 7 includes “https://weather01.com” as a URL indicating the next access destination (a target URL in the example of FIG. 10). The mobile terminal 7 generates a request that includes the URL “https://weather01.com” indicating the next access destination in a header.

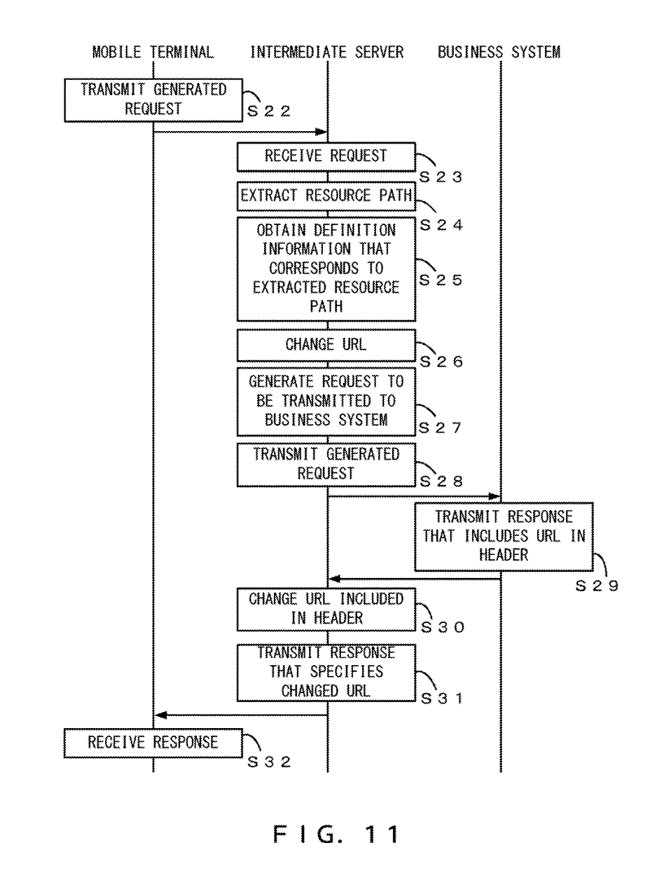

A process in which the mobile terminal 7 transmits a request according to a response and the processes that follow are described next with reference to the example of FIG. 11.

As illustrated in the example of FIG. 11, the mobile terminal 7 transmits the generated request to the intermediate server 5 via the second network 6 (step S22). The intermediate server 5 receives the request (step S23). Upon receipt of the request, the gateway function unit 13 performs authentication or the like on the request, as described above.

When authentication is successful, the gateway function unit 13 stores, in the storing unit 16, the entry point URL in the URL specified by the request.

The request received by the intermediate server 5 is “https://host/api/tenant01/weather/real”, and the entry point URL is “https://host/api/tenant01/weather”. This entry point URL is stored in the storing unit 16.

The control unit 12 extracts a resource path that is included in the URL specified by the request (step S24). As described above, a character string at the end of the entry point URL is “weather”, and this character string is extracted.

The control unit 12 obtains definition information indicating that an API definition name is “weather” from the definition information database 3 (step S15). The changing unit 15 changes the URL on the basis of the URL specified by the request and the obtained definition information (step S15).

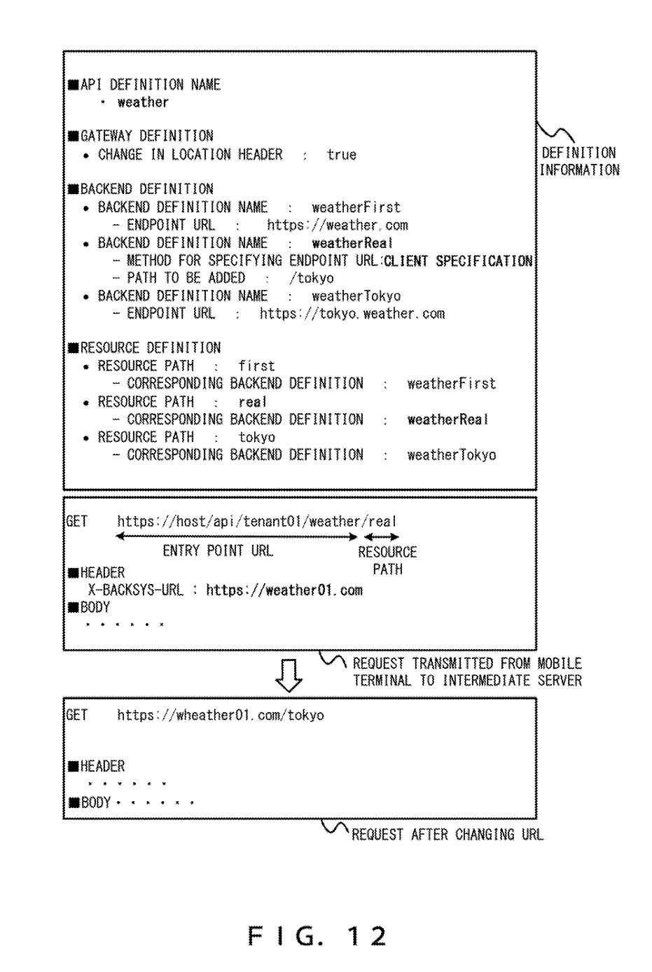

Processing for changing a URL is described with reference to the example of FIG. 12. The changing unit 15 extracts a resource path in the URL specified by the request. In the example of FIG. 12, the resource path is “real”. The changing unit 15 searches the resource definition in the obtained definition information for an item that matches the extracted resource path.

In the example of FIG. 12, an item that matches the resource path “real” is detected from the resource definition. The changing unit 15 extracts the backend definition “weatherReal” that corresponds to the detected item in the resource definition.

The changing unit 15 searches the backend definition for an item that matches the extracted “weatherReal”. In the example of FIG. 8, an item that matches the backend definition name “weatherReal” is detected.

In the backend definition name “weatherReal”, the endpoint URL has been specified as a client specification. When the endpoint URL has been specified as a client specification, the endpoint URL can be specified arbitrarily.

In the embodiments, assume that a URL included in a header of a request is specified as an endpoint URL. In the example of FIG. 12, “https://weather01.com” is included in the header of the request. This URL is specified as an endpoint URL.

In the backend definition name “weatherReal” of the definition information, “/Tokyo” has been specified as a path to be added. The changing unit 15 adds the path to the end of the endpoint URL above.

The changing unit 15 changes the URL specified by the request. The changed URL is “https://weather01.com/Tokyo” in which the path has been added to the end of the endpoint URL above, as illustrated in the example of FIG. 12. The changed URL is a URL according to the definition information, and is a URL that is valid in the first network 4.

As illustrated in the example of FIG. 11, the system cooperation unit 14 generates a request that specifies the changed URL (step S27). This request is a request to be transmitted to the business system 1.

The communication unit 11 transmits the generated request to the business system 1 via the first network 4 (step S28). The request is transmitted to the business server 2 that is an access destination indicated by the URL specified by the request in the business system 1.

The business server 2 that has received the request transmits to the intermediate server 5 a response to the request (step S29). The business server 2 may make a transmission source of the request transmit another request, as described above.

In this case, a URL to be accessed next by the transmission source of the request is included in a header or a body of the response. Assume that, in step S29, the URL to be accessed next is specified by a location header included in the header of the response.

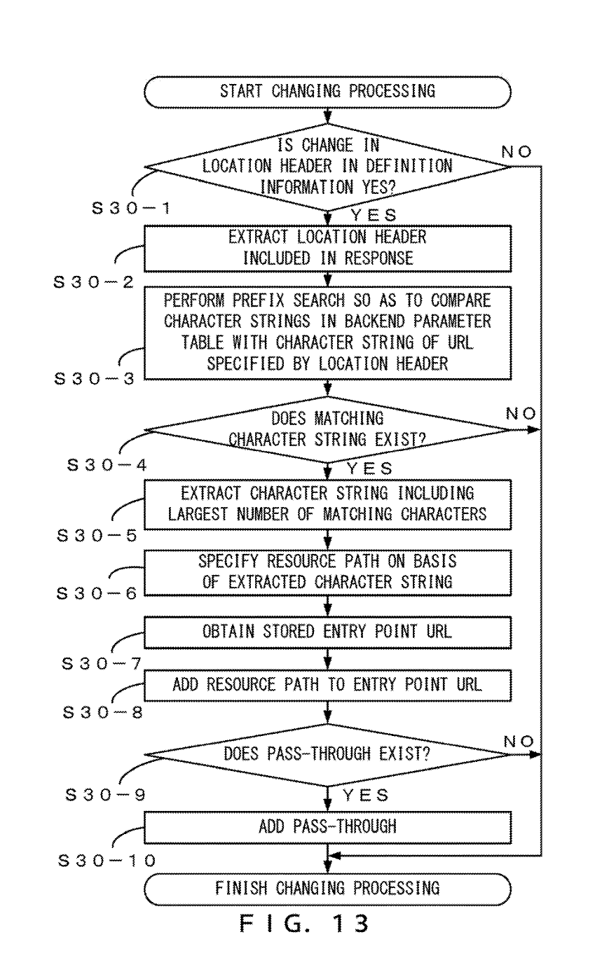

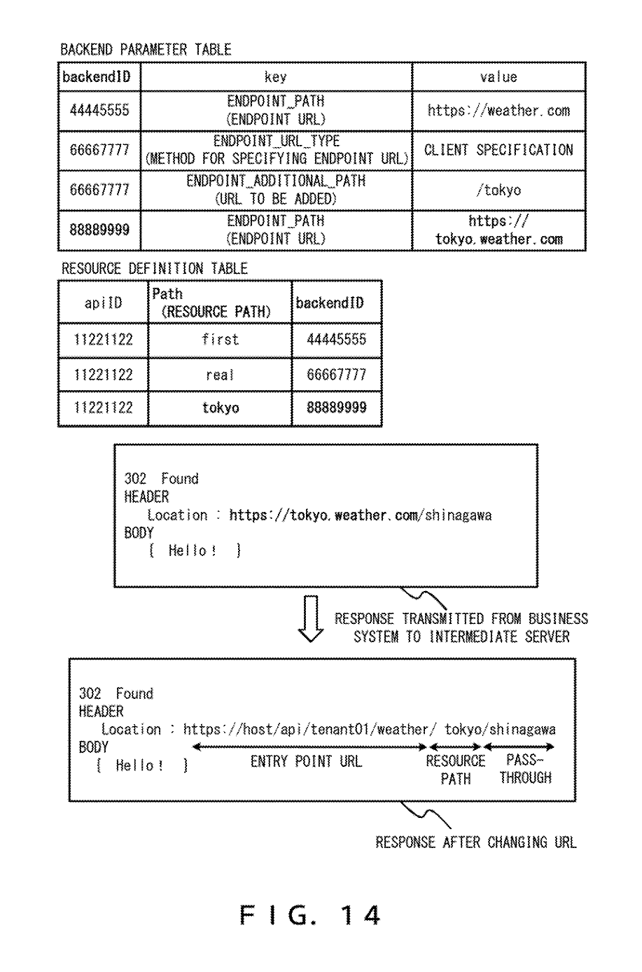

The communication unit 11 of the intermediate server 5 receives the response transmitted from the business server 2, and the changing unit 15 changes the URL specified by the location header of the response (step S30). Processing for changing the URL specified by the location header of the response is described with reference to FIGS. 13 and 14.

FIG. 13 is a flowchart illustrating an example of a flow of processing for changing the URL specified by the location header of the response. As described above, the intermediate server 5 has already obtained definition information indicating that an API definition name is “weather”.

The changing unit 15 references the item “gateway definition” in the definition information, and determines whether a change in the location header is “true” (step S30-1). When a change in the location header is “NO” (NO instep S30-1), the URL specified by the location header included in the response is not changed. That is the location header included in the response is refrained from changing.

When a change in the location header is “true” (YES in step S30-1), the changing unit 15 extracts the URL specified by the location header included in the response (step S30-2).

As an example, in the example of FIG. 14, a URL specified by a location header included in a response transmitted from the business system 1 to the intermediate server 5 is “https://tokyo.weather.com/shinagawa”. The changing unit 15 extracts this URL.

The changing unit 15 performs a prefix search so as to compare character strings in “value” of the backend parameter table with a character string of the URL specified by the location header (step S20-3). Stated another way, the changing unit 15 performs searching so as to determine whether each of the character strings in “value” of the backend parameter table matches the character string of the URL specified by the location header sequentially from the top of the character string.

The changing unit 15 determines whether a matching character string exists (step S30-4). When a matching character string does not exist (NO in step S30-4), the changing unit 15 does not change the URL specified by the location header even when, in the gateway definition in the definition information, a change in the location header has been set to “true”.

When a matching character string exists (YES in step S30-4), the changing unit 15 extracts a value that includes the largest number of matching characters (step S30-5).

In the example of FIG. 14, in “value” of the backend parameter table, two character strings, “https://weather.com” and “https://tokyo.weather.com”, front-match with the above URL specified by the location header, and the front-matching character string is “https://”.

From among the two character strings above, the character string “https://tokyo.weather.com” includes a larger number of matching characters. The changing unit 15 extracts the character string “https://tokyo.weather.com”.

The changing unit 15 specifies a resource path on the basis of the extracted character string “https://tokyo.weather.com” (step S30-6).

In the example of FIG. 14, the value “88889999” of “backendId” that corresponds to the extracted character string “https://tokyo.weather.com” is specified in the backend parameter table. The changing unit 15 searches “Path” in the resource definition table by using this value as a key, and detects “tokyo” as a resource path. Consequently, the resource path is specified.

The changing unit 15 obtains an entry point URL stored in the storing unit 16 (step S30-7). As described above, upon receipt of a request from the mobile terminal 7 via the second network 6, the control unit 12 stores the entry point URL in the URL specified by the request in the storing unit 16.

The response transmitted from the business system 1 is a response to the request, and the changing unit 15 obtains, from the storing unit 16, an entry point URL that has been specified by the request that corresponds to the response.

As described above, an entry point URL in the URL specified by the request that the intermediate server 5 has received from the mobile terminal 7 is “https://host/api/tenant01/weather”. The changing unit 15 obtains this entry point URL from the storing unit 16.

The changing unit 15 adds the specified resource path to the end of the entry point URL (step S30-8). The changing unit 15 then determines whether a pass-through is included in the response transmitted from the business system 1 (step S30-9).

When a pass-through is not included (NO in step S30-9), a pass-through is not added. When a pass-through is included (YES in step S30-9), the changing unit 15 adds the pass-through to the end of the resource path that has been added to the entry point URL.

In the example of FIG. 14, the pass-through “/shinagawa” is included in the response transmitted from the business system 1. Accordingly, the changing unit 15 adds this pass-through to the end of the resource path. Consequently, as illustrated in the example of FIG. 14, the URL specified by the location header of the response is changed.

The changed URL is a URL that is valid in the second network 6, but is not a URL that is valid in the first network 4. However, the changed URL is a URL by which the mobile terminal 7 can access the business system 1 via the intermediate server 5. Accordingly, the mobile terminal 7 can access the business system 1 via the intermediate server 5.

As illustrated in the example of FIG. 11, after the URL specified by the location header has been changed, the intermediate server 5 transmits a response that includes a location header specifying the changed URL to the mobile terminal 7 via the second network 6 (step S31).

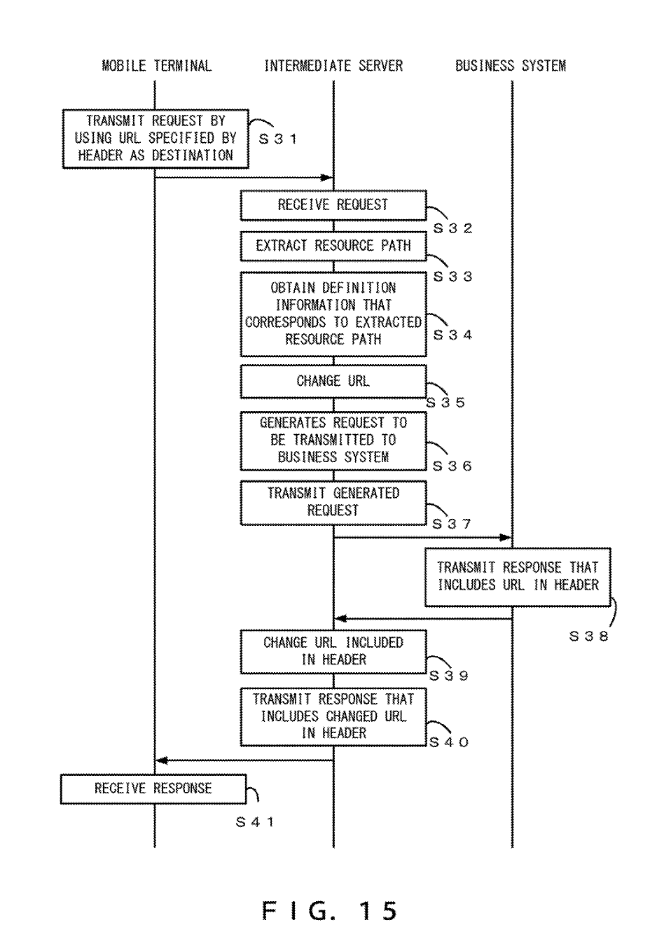

The mobile terminal 7 receives the response (step S32). Processing after the response is received is described with reference to the example of FIG. 15 of a sequence chart.

When a location header is included in the received response, the mobile terminal 7 generates a request that indicates the URL specified by the location header as a destination, and transmits the request to the intermediate server 5 via the second network 6 (step S31).

The intermediate server 5 receives the request (step S32). Upon receipt of the request, the gateway function unit 13 performs authentication or the like on the request. The control unit 12 extracts a resource path that is included in the URL specified by the request (step S33).

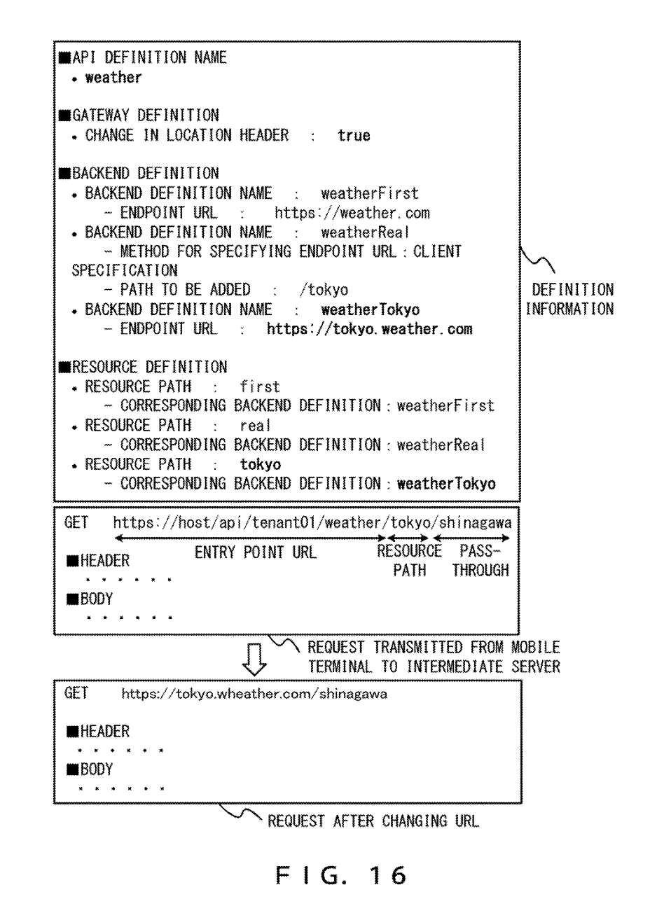

The control unit 12 obtains definition information that corresponds to the extracted resource path from the definition information database 3 (step S34). The changing unit 15 changes the URL on the basis of the URL specified by the request and the obtained definition information (step S35). Processing for changing a URL is described with reference to the example of FIG. 16.

The changing unit 15 extracts a resource path from the URL specified by the request. In the example of FIG. 16, the resource path is “tokyo”. The changing unit 15 searches the resource definition in the obtained definition information for an item that matches the extracted resource path.

In the example of FIG. 16, an item that matches the resource path “tokyo” is detected from the resource definition. The changing unit 15 extracts the backend definition “weatherTokyo” that corresponds to the detected item in the resource definition.

The changing unit 15 searches the backend definition for an item that matches the extracted “weathertTokyo”. In the example of FIG. 16, an item that matches the backend definition name “weatherTokyo” is detected.

The changing unit 15 extracts “https://tokyo.weather.com” that is an endpoint URL that corresponds to the detected backend definition name. The changing unit 15 changes the URL specified by the request to the endpoint URL above.

The pass-through “/shinagawa” is included in the URL specified by the request. The changing unit 15 adds the pass-through to the end of the changed endpoint URL. Consequently, the URL received from the mobile terminal 7 is changed to the URL illustrated in the example of FIG. 16.

The process of step S35 for changing a URL is similar to the process illustrated in the example of FIGS. 9 and 10. The changed URL is a URL that is valid in the first network 4.

The URL specified by the request is a URL that has been specified by the location header included in the response that the mobile terminal 7 has received. The URL specified by the location header is a URL to which the changing unit 15 has changed the URL that has been specified by the location header included in the response that has been received from the business system 1.

As described above, the changing unit 15 changes the URL that has been specified by the location header included in the response in such a way that the mobile terminal 7 can access the business system 1 via the intermediate server 5.

In the example of FIG. 16, the URL is changed to “https://host/api/tenant01/weather/tokyo/shinagawa”. The changing unit 15 can change the URL specified by the request to a URL that enables the business system 1 to be accessed (a URL that is valid in the first network 4), on basis of the URL above.

Accordingly, the intermediate server 5 can transmit, to the business system 1, the request received from the mobile terminal 7.

As illustrated in the example of FIG. 15, the system cooperation unit 14 generates a request to be transmitted to the business system 1 that specifies the changed URL (step S36).

The communication unit 11 transmits the generated request to the business system 1 via the first network 4 (step S37). The request is transmitted to the business server 2 that is an access destination that is indicated by the URL specified by the request in the business system 1.

The business server 2 that has received the request transmits a response to the request to the intermediate server 5 (step S38). A URL to be accessed next by a transmission source of the request may be included in a header of the response.

In this case, the changing unit 15 performs a process similar to the above process of step S30 so as to change the URL included in the header of the response (step S39).

The intermediate server 5 receives the response. The system cooperation unit 14 controls the gateway function unit 13 so as to transmit the received response to the mobile terminal 7 that is a transmission source of the request (step S40). The mobile terminal 7 receives the response (step S41).

As described above, upon receipt of the request, the business server 2 may include, in a response, a URL indicating an access destination to be accessed next by an access source. This URL is valid in the first network 4, but is invalid in the second network 6 that is different from the first network 4.

From the viewpoint of security to the business system 1, or the like, the intermediate server 5 controls access from the second network 6. When the intermediate server 5 receives, from the business system 1, a response indicating a URL of a destination to be accessed next, the intermediate server 5 changes the URL included in the response.

In this case, the changing unit 15 of the intermediate server 5 changes the URL in such a way that the mobile terminal 7 can access the business system 1 via the intermediate server 5.

Consequently, when the intermediate server 5 receives a request according to a response from the mobile terminal 7, the intermediate server 5 can transmit the request to a URL of the business system 1, specified by the response without denying the request.

The intermediate server 5 performs processing for changing a URL, and therefore when the intermediate server 5 receives a request based on a response from the mobile terminal 7, the request is not denied even when the business system 1 is not modified.

### <Example of Hardware Configuration of Intermediate Server>

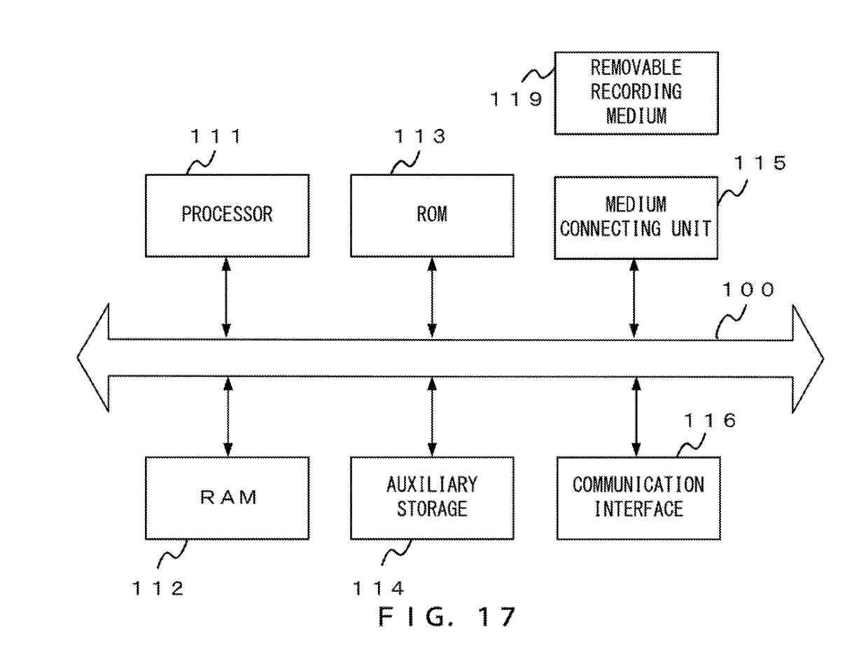

An example of a hardware configuration of the intermediate server 5 is described next with reference to the example of FIG. 17. As illustrated in the example of FIG. 17, a processor 111, a RAM 112, a ROM 113, an auxiliary storage 114, a medium connecting unit 115, and a communication interface 116 are connected to a bus 100.

The processor 111 is an arbitrary processing circuit. The processor 111 executes a program deployed in the RAM 112. As a program to be executed, a program for performing processing according to the embodiments may be employed. The ROM 113 is a non-volatile storage that stores the program deployed in the RAM 112.

The auxiliary storage 114 is a storage that stores various types of information. As an example, a hard disk drive, a semiconductor memory, or the like may be employed as the auxiliary storage 114. The medium connecting unit 115 is provided so as to be able to be connected to a removable recording medium 119.

As the removable recording medium 119, a removable memory or an optical disk (such as a Compact Disc (CD) or a Digital Versatile Disc (DVD)) may be employed. A program for performing processing according to the embodiments may be recorded in the removable recording medium 119.

In the intermediate server 5, the communication unit 11 may be implemented by the communication interface 116. The storing unit 16 may be implemented by the RAM 112, the auxiliary storage 114, or the like.

The control unit 12, the gateway function unit 13, the system cooperation unit 14, and the changing unit 15 may be implemented by the processor 111 executing a given communication control program.

All of the RAM 112, the ROM 113, the auxiliary storage 114, and the removable recording medium 119 are examples of a computer-readable non-transitory recording medium. These non-transitory recording mediums are not transitory mediums such as a signal carrier.

### <Others>

According to the embodiments, access can be performed from an external network via an intermediate server.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a communication control program that causes a computer to execute a process comprising:
receiving a request to be transmitted to an information processing system coupled to a first network that selectively allows the computer to perform access from an outside of a network, from a terminal device coupled to a second network being different from the first network;
changing, when a response obtained as a result of transmitting the request to the information processing system includes location information indicating an access destination in the first network, the location information to location information for accessing the information processing system; and
transmitting the response including the changed location information to the terminal device.

2. The non-transitory computer-readable recording medium according to claim 1, the process further comprising:
receiving a request including the changed location information from the terminal device;
changing the location information included in the request to location information indicating the access destination in the first network; and
transmitting the request to the access destination indicated by the changed location information.

3. The non-transitory computer-readable recording medium according to claim 1, the process further comprising:
changing the location information included in the response to the location information for accessing the information processing system on the basis of definition information that defines rules for changing the location information and a character string of the location information included in the response.

4. The non-transitory computer-readable recording medium according to claim 3, the process further comprising:
performing searching so as to determine whether a plurality of character strings defined by the definition information match the character string of the location information included in the response sequentially from a top of the character string, and specifying a character string that includes a largest number of matching characters to be a character string to be changed, from among the plurality of character strings defined by the definition information.

5. The non-transitory computer-readable recording medium according to claim 4, the process further comprising:
adding, when a second character string is added to an end of a first character string indicating an access destination in the location information included in the response, the second character string to the changed location information.

6. The non-transitory computer-readable recording medium according to claim 4, the process comprising:
refraining from changing, when the definition information includes a definition to change the location information included in the response, and when the plurality of character strings do not match the location information included in the response, the location information included in the response.

7. The non-transitory computer-readable recording medium according to claim 2, the process further comprising:
changing the location information included in the request to the location information for accessing the information processing system on the basis of definition information that defines rules for changing the location information and a character string of the location information included in the request.

8. A communication control method conducted by a processor, the communication control method comprising:
receiving a request to be transmitted to an information processing system coupled to a first network that selectively allows the computer to perform access from an outside of a network, from a terminal device coupled to a second network being different from the first network;
changing, when a response obtained as a result of transmitting the request to the information processing system includes location information indicating an access destination in the first network, the location information to location information for accessing the information processing system; and
transmitting the response including the changed location information to the terminal device.

9. A communication control device comprising:
a processor configured to execute a process including:
receiving a request to be transmitted to an information processing system coupled to a first network that selectively allows the computer to perform access from an outside of a network, from a terminal device coupled to a second network being different from the first network;
changing, when a response obtained as a result of transmitting the request to the information processing system includes location information indicating an access destination in the first network, the location information to location information for accessing the information processing system; and
transmitting the response including the changed location information to the terminal device.
